(19) United States
(12) Patent Application Publication
(10) Pub. No.: US 2008/0122726 A1
(43) Pub. Date: May 29, 2008

(54) Low cost chip package with integrated RFantenna

(76) Inventors: Gil Levi, Beit Hanan (IL); Alexander Toshev, Sofia (BG)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/743,681

(22) Filed: May 3, 2007

Related U.S. Application Data
(60) Provisional application No. 60/861,145, filed on Nov. 27, 2006.

(51) Int. Cl. H01Q 1/40

(52) U.S. Cl. 343/873

(57) ABSTRACT

An electronic RF chip package with integrated antenna includes a top cover section having on its external surface an integrated antenna with antenna elements resonating at different polarizations, a RF chip mounted on an internal surface of the top cover section and functionally coupled to the antenna elements to provide the different polarizations and a bottom cover section shaped to accommodate the RF chip. The RF functional coupling is provided through radiating coupling slots or vias formed in the top cover section.

### CROSS REFERENCE TO RELATED APPLICATIONS

The present invention claims priority from U.S. Provisional Patent Application No. 60/861,145 filed Nov. 27, 2006, the contents of which are incorporated herein by reference

### FIELD OF THE INVENTION

The present invention relates in general to radio frequency (RF) chips and packages, and in particular to RF chips packaged in packages having integrated antennas.

### BACKGROUND OF THE INVENTION

Wireless communications require an antenna to transmit and receive signals in the form of electromagnetic radiation. The antenna is driven by a discrete device or an integrated circuit (IC), also referred herein as an “RF chip”. This “driver” chip is typically located in a package attached to a printed circuit board (PCB) along with other electronic circuitry. The signal from the driver chip (also referred herein as an “RF chip”) reaches the antenna through a wire or cable.

Integrated circuits with a wireless RF interface are known. Applications of such RF ICs include keyless-entry automobile security systems, secure identification badges, antitheft devices, localized RF data communications between computing devices, localized wireless voice communications and cellular telephones. Recent designs have incorporated metallic RF antennas into the IC package, see e.g. U.S. Pat. No. 7,119,745 to Gaucher et al, U.S. Pat. No. 7,095,372 to Soler Castany et al, U.S. Pat. No. 6,914,566 to Beard and U.S. Pat. No. 6,239,752 to Blanchard, as well as US Patent Application No. 2001/0052654 by Op'T Eynde et al. This incorporation provides additional compactness, and exploits the high frequency capabilities of contemporary integrated circuits. Furthermore, in U.S. Pat. No. 6,239,752, the antenna serves as the package for the semiconductor driver chip. The requirement for a separate package to house the driver chip as well as for the wire or cable between the driver chip and the antenna are eliminated. When the back surface of the driver chip is an active terminal of the driver chip, the need for a separate load to that region may also be eliminated.

In all prior art solutions that the present inventors are aware of, there is a recurring problem in connecting the RF chip (die) and the antenna. The assembly of RF chips into packages is costly and there is no antenna with multiple input-multiple output (MIMO) support on the chip, because there is a minimum required distance of half a wavelength between antenna elements.

There is therefore a need for and it would be advantageous to have a RF chip package that includes MIMO support on the RF chip and which does not suffer from the problems in the prior art solutions.

### SUMMARY OF THE INVENTION

The present invention discloses a low cost package for a RF chip. The RF circuitry of the chip must be connected to an antenna for transmission and reception of RF signals. This antenna is integrated into the package and is therefore part of the packaged chip. The integrated antenna, made of one or more antenna elements, is preferably printed on an external surface of a top cover section of the package. The top cover section is preferably a circuit board, made of a material capable of providing the needed characteristics to the antenna.

The integrated antenna utilizes MIMO technology, which requires multiple antenna elements uncorrelated in their transmission characteristics to gain diversity between the different elements of the MIMO system. In order to solve the problem of the required minimum distance of ½ wavelength between antenna elements, which essentially prevented the integration of MIMO technology in prior art, the present invention uses polarization diversity instead of space diversity and elements that support at least 2 antenna feeds each at a different polarization on a substantially smaller footprint. In an exemplary implementation for the Industrial Scientific Medical (ISM) Band at 5 GHz (for which the wavelength is 60 mm), the entire package footprint is smaller than 25 mm×25 mm, with one radiating element having two feeds, each feed radiating at a different orthogonal polarization, (e.g. horizontal and vertical), thus suitable for MIMO technology with polarization diversity.

According to the present invention there is provided an electronic package including a top cover section including at least one antenna element formed on an external surface thereof and a chip with RF circuitry mounted on an internal surface thereof, at least one antenna feed for functionally coupling the RF circuitry to the at least one antenna element and a bottom cover section enclosing the chip and joined to the top cover section.

According to the present invention there is provided an electronic package including a top cover section having an integrated antenna with a plurality of antenna elements resonating at different polarizations formed on an external surface thereof, a RF chip mounted on an internal surface of the top cover section and functionally coupled to the antenna elements to provide the different polarizations and a bottom cover section shaped to accommodate the RF chip, the top and bottom sections joinable into a single package unit.

According to the present invention there is provided a method for providing an electronic package for an RF chip, including the steps of providing a top cover section having an integrated antenna with a plurality of antenna elements resonating at different polarizations formed on an external surface thereof; providing a bottom cover section shaped to accommodate a RF chips the top and bottom sections joinable into a single package unit; mounting the RF chip on an internal surface of the top cover, and coupling the RF chip to the antenna elements to provide antenna resonances at different polarizations.

### BRIEF DESCRIPTION OF THE DRAWINGS

The invention is herein described, by way of example only, with reference to the accompanying drawings, wherein:

FIG. 1A shows a first embodiment of a package with integrated RF antenna according to the present invention in an isomeric view;

FIG. 1B shows a first embodiment of a package with integrated RF antenna according to the present invention in cross section;

FIG. 2A shows the top cover section of the package from a top surface view;

FIG. 2B shows the top cover section of the package from a bottom surface view;

FIG. 2C shows the bottom surface view of FIG. 2B with an RF chip mounted thereon;

FIG. 2D shows the top cover section of the package in an alternative embodiment from top and bottom surface views;

FIG. 3A shows the bottom surface of the top plate of the top cover section of FIG. 1;

FIG. 3B shows the top surface of the bottom plate of the top cover section of FIG. 1;

FIG. 4A shows a top layer of a single element patch antenna having two feeds, each at a different polarization;

FIG. 4B shows a middle layer of the antenna of FIG. 4A;

FIG. 4C shows a bottom layer of the antenna of FIG. 4A;

FIG. 4D shows all three layers in FIGS. 4A, 4B and 4C superimposed from a top view;

FIG. 4E shows the three layer structure of the antenna in FIG. 4D in cross section;

FIG. 5A shows the bottom cover section of the package of FIG. 1 from a top surface view;

FIG. 5B shows the bottom cover section of the package of FIG. 1 in cross section.

In the following description like elements in different figures are marked with identical numbers.

### DETAILED DESCRIPTION OF THE INVENTION

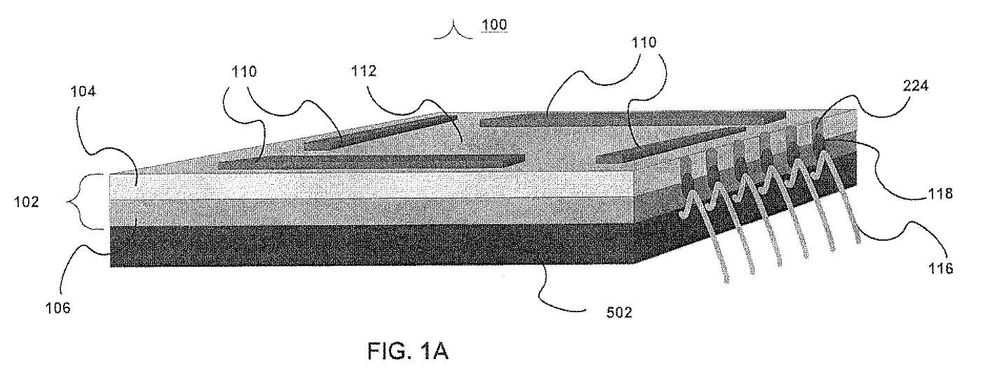

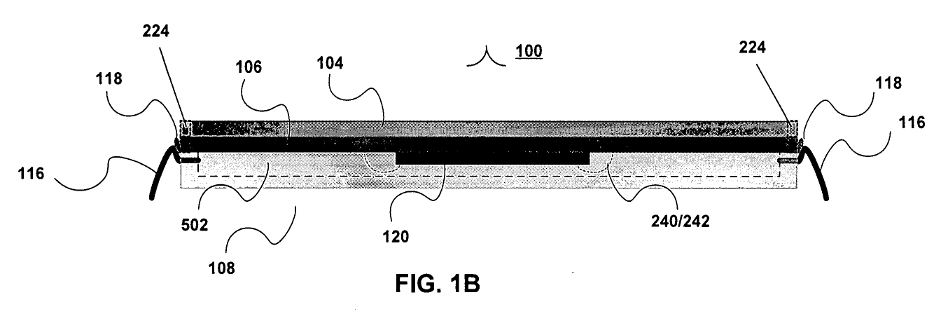

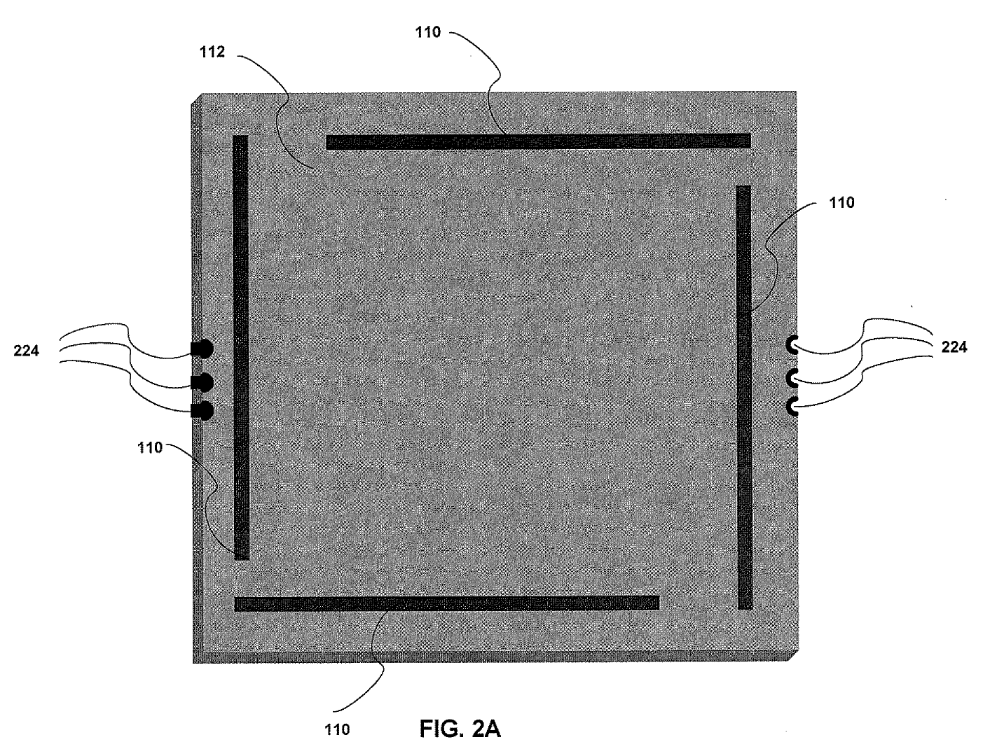

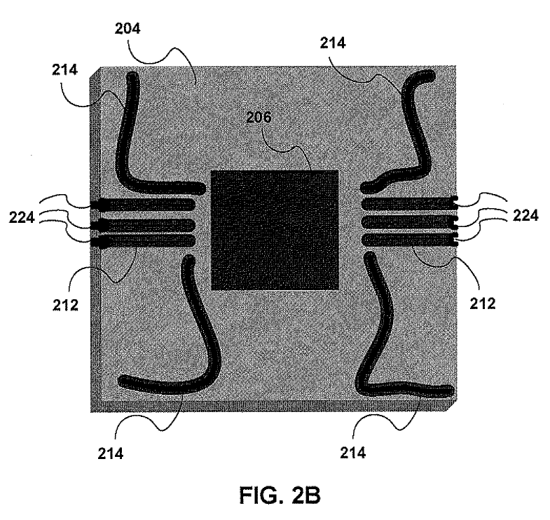

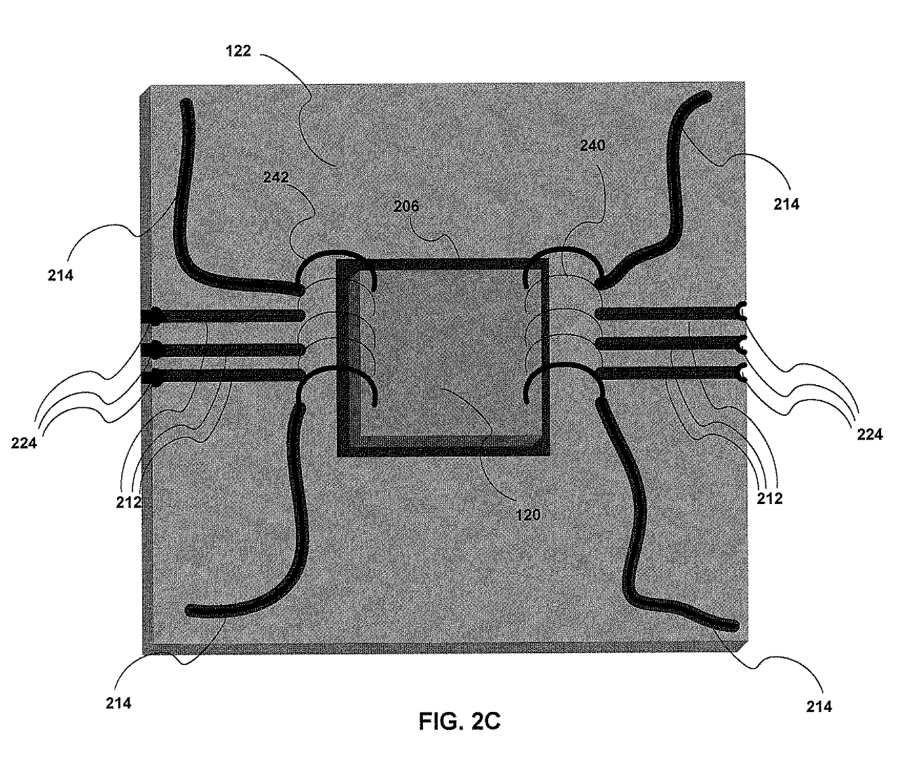

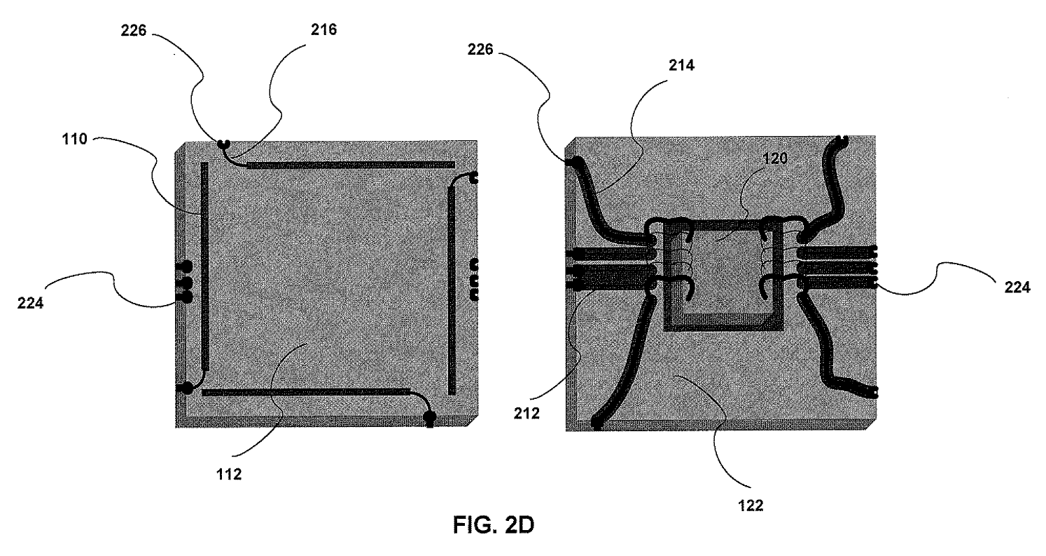

FIGS. 1A and 1B show a first embodiment of a low cost chip package with integrated RF antenna 100 of the present invention. Package 100 comprises a top cover section 102 having two carrier plates, a top plate 104 (also marked “PCB A”) and a bottom plate 106 (also marked “PCB B”) and a bottom cover section 108, which includes a plate 502 and leads 116. Leads 116 (e.g. metallic pins or other types of conductor leads) are used to connect the package electrically and mechanically to external bond pads on a carrier substrate such as a PCB. Leads 116 are usually soldered to the carrier substrate. Top plate 104 has four associated antenna elements 110 formed on a top surface 112 thereof. Note that the number of “four” is not limiting, and that an antenna of the present invention may be implemented using less or more than 4 antenna elements. The antenna element or elements may have different polarizations (at least two), thereby implementing polarization diversity. For example, the antenna elements may provide horizontal and vertical components of electromagnetic fields, or right hand circular and left hand circular components of the electromagnetic field. Antenna elements 110 are formed preferably by printing, but may also be formed by other techniques. Bottom plate 106 has a bottom surface 122 (see FIG. 2C) with an RF chip 120 attached thereon. Surface 122 may be metallic, or made of a bare PCB material such as FR4 or of any other material used for PCB B. Chip 120 is connected electronically to top cover section 102 through wire bonds. These are separated into conventional wire bonds 240 and RF wire bonds 242. Conventional wire bonds 240 are connected to conduction leads 116 through conventional feeds 212 and connection vias 224. Vias 224 run along a side edge surface of the top cover section and are used for example for electrical connections to leads 116. As shown in FIGS. 1A and 1B, vias 224 and leads 116 are welded through weld points 118. Chip 120 is covered by bottom cover section 108. Cover section 108 may be made of various materials, for example plastics, foams, PCBs or metals.

The two-plate construction of the cover section is advantageous in that it allows easy formation of radiating coupling slots 402 internal to the cover section, see below. In some embodiments in which the coupling slots are replaced by radiating vias 226, see below, the two carrier plates of the top cover section may be combined into a single plate. In some embodiments, the carrier plates are printed circuit boards (PCBs). In other embodiments, the carrier plates may be made of other materials, for example ceramics, foams or plastics. Hereinafter, all carrier plates will be referred to for convenience as “PCBs”. In some embodiments, at least one carrier plate may be a multilayer PCB, and/or may integrate other layers with different functionalities. Each of the main components of package 100 is now described in more detail.

### Top Cover Section 102

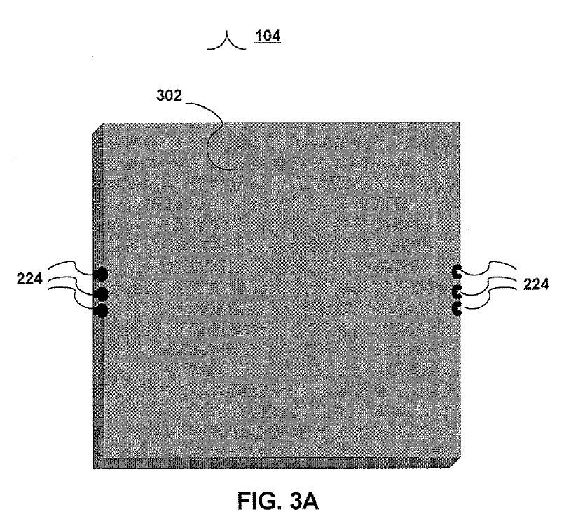

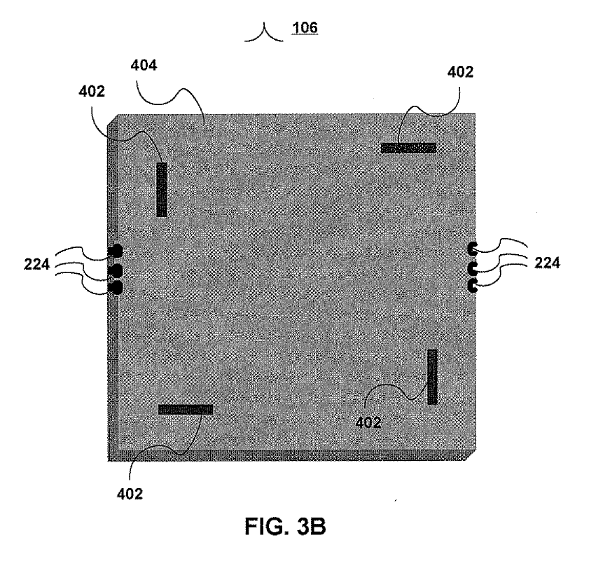

FIG. 2 show top cover section 102 in three different views. FIG. 2A shows the top cover section from a top-side view (which is also the top view of top plate 104). Top surface 112 can either be a metallic surface, a bare PCB material such as FR4, or any other material used for PCB A. The top view also shows antennas 110 and connection vias 224. FIG. 2B shows top cover section 102 from a bottom view (which is also the bottom view of bottom plate 106). Conventional feeds 212 are shown on the bottom connected to connection vias 224, which are later connected to leads 116 by e.g. soldering or welding. A bottom surface 204 includes an area 206 for mounting chip 120 thereon. The bottom surface with the mounted chip is shown in FIG. 2C. RF signals are led between RF wire bonds 242 (FIG. 2C) and antenna elements 110 by antenna RF feeds 214. In one embodiment, RF feeds 214 running along the bottom surface of bottom plate 106 are inventively radiated to antenna elements 110 through coupling slots 402 formed in a top surface 404 (see FIG. 3B) of bottom plate 106, FIG. 3B. Slots 402, which are essentially small grooves formed in the plate, are positioned opposite end sections of RE feeds 214. The dimensions of the coupling slots depend on a number of parameters and may be obtained using known electromagnetic radiation simulation tools. The advantage of the two-plate structure of top cover section 102 becomes now clear: slots 402 can be easily manufactured into surface 404, with plates 104 and 106 then joined, for example by gluing, to form the top cover section.

An alternative embodiment is shown in FIG. 2D, which shows the top cover section from a top view (left) and a bottom view (right). Here, radiating coupling slots 402 are replaced by vias 226 as radiation conduits to antenna feeds 214. Consequently, top-cover section 102 may be made of a single plate instead of the two carrier plate construction above. Vias 226 can be positioned either on the side edges of the PCB, as done with connection vias 224 and as shown, or anywhere within the PCB (not shown). Vias 226 are then connected on the top surface (left) to antenna elements 110 through RF feeds 216.

FIG. 3 shows additional details of the top and bottom plates. FIG. 3A shows the top plate PCB A from a bottom view. PCB A has a bottom surface 302 which can be either fully or partially metallic, a bare PCB material such as FR4 or any other material used for PCB A. FIG. 3B shows the bottom plate PCB B from a top view. PCB B has on its top side a metallic surface (ground plane) 404 with radiating coupling slots 402 (discussed above). In this embodiment, slots 402 are non-metallic and are used to induce the signal present in bottom RF feeds 214 to antenna radiating elements 110 on the top surface of PCB A.

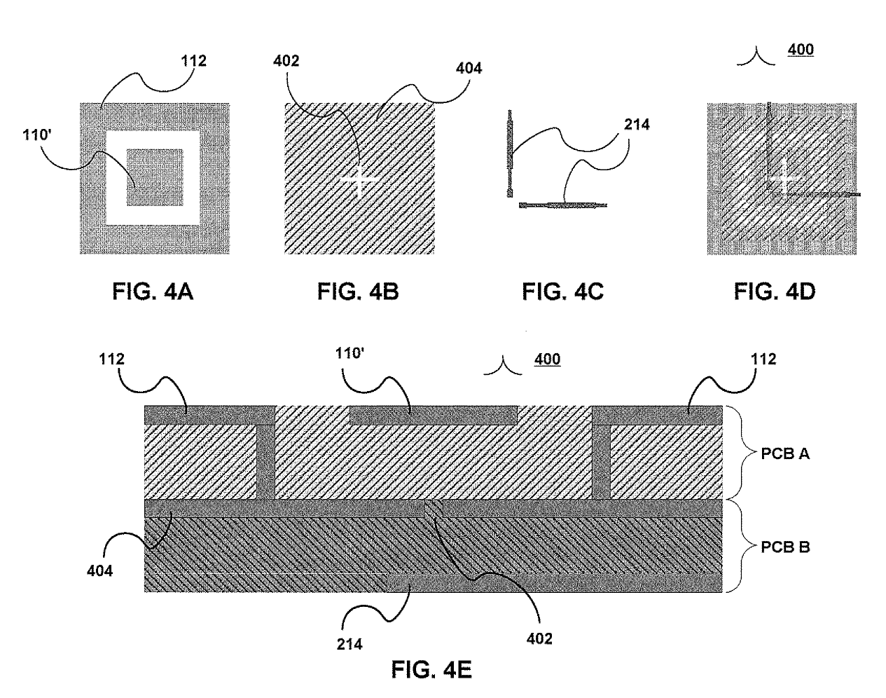

The antenna elements, shown in FIGS. 1 and 2 as straight elements 110, may be implemented in various shapes and configurations. FIGS. 4 shows an embodiment of a dual-polarized antenna element. FIG. 4A shows the top layer of the antenna element from a top view. FIG. 4A shows a radiating element 110′ along with metallic ground surface 112. The feeds to element 110′ are induced by radiating coupling slots 402 in ground plane 404 shown in FIG. 4B, which shows the middle layer of the antenna element from a top view. Slots 402 and ground plane 404 are placed below radiating element 110′. FIG. 4C shows the bottom layer of the antenna element from a top view. The bottom layer is positioned below both top (4A) and middle (4B) layers. FIG. 4C depicts RF feeds 214 to be connected to antenna elements 110 through radiating slots 402. There are two RF feeds 214, each operative to be radiated by antenna element 110′ at different (orthogonal) polarizations, in a manner well known in the art. Exemplarily, for RF feeds 214, one polarization is vertical and the other horizontal. FIG. 4D shows the superimposed three layers of FIGS. 4A, 4B and 4C, which together form a combined structure of an antenna element and its two feeds. FIG. 4E shows a cross-section view of the three-layer antenna element as implemented through PCB A and PCB B. The three-layer structure is marked by numeral 400. While this embodiment of a dual polarization antenna is shown for a single element, multiple elements may be implemented on top cover 102, working together as a single antenna or separately as multiple antennas, according to the needs of the application of each packaged chip. Further, while the antenna elements shown in FIGS. 1, 2 and 4 are fed by use of radiating coupling slots or vias, other types of feeds may be used.

### Bottom Cover Section 108

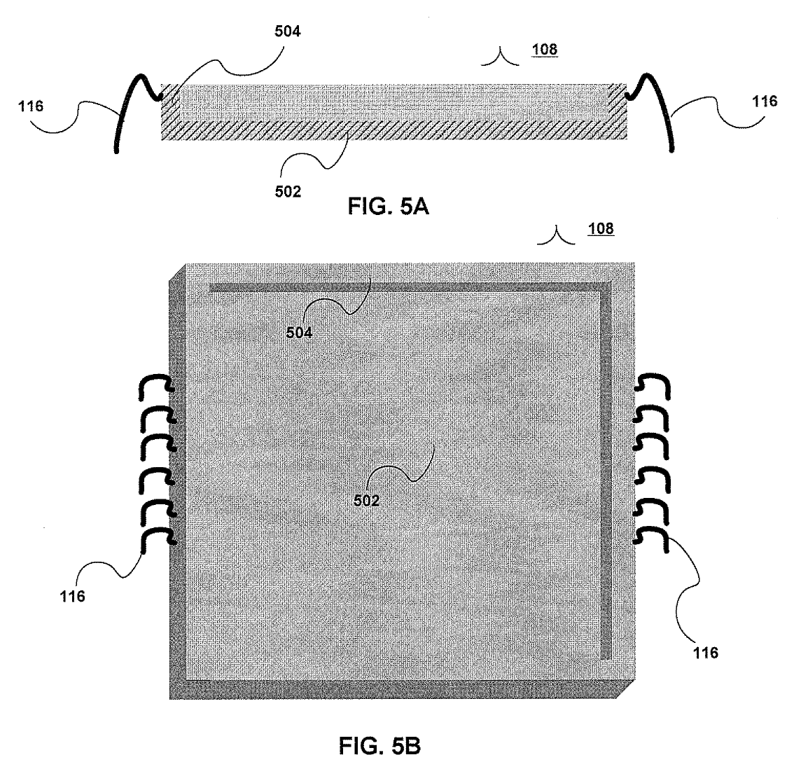

FIG. 5 shows in more detail bottom cover section 108. FIG. 5A shows bottom cover 108 in cross section, while FIG. 5B shows bottom cover 108 in top view. Cover 108 may be made of plastic or similar material. In one embodiment, cover 108 is shaped as a base plate 502 with a surrounding relief “wall” 504. The relief provides a space to accommodate the chip when bottom cover 108 is joined with top cover 102.

### Assembly

In a case where the top-cover PCB is made of two PCB layers using RE radiating coupling slot feeds, PCB A is attached to PCB B by, for example, gluing. Chip 120 is then mounted on the top-cover PCB on the side of PCB B and its inputs/outputs (I/Os) are bonded with wire bonds (240, 242) to the feeds (both RF feeds 214 and standard feeds 212) through pads prepared on PCB B (which are part of the feeds themselves and are not explicitly shown). The mounted chip is then placed upside down on bottom-cover 108 and connection vias 224 are connected to chip leads 116 through a low cost process such as welding (see e.g. welding points 118). The metallic pins or chip leads 116 are shaped in a manner which enables them to be easily welded to connection vias 224, which are normally plated. The chip is then fully assembled. The top and bottom cover sections may then be joined by well known means such as gluing, and the package may be hermetically closed, using well established processes.

The assembly process and the package itself are advantageously low cost, not significantly higher than any other assembly and packaging processes for RF applications at similar frequencies, but in which the antenna is not integrated on the package. Most advantageously, the integration of the antenna on the package and the use of polarization diversity provide significant advantages, such as removal of the ½ wavelength restriction and enablement of MIMO support.

All publications and patents mentioned in this specification are incorporated herein in their entirety by reference into the specification, to the same extent as if each individual publication or patent was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. An electronic package comprising:
a. a top cover section including at least one antenna element formed on an external surface thereof and a chip with radio frequency (RF) circuitry mounted on an internal surface thereof;
b. at least one antenna feed for functionally coupling the RF circuitry to the at least one antenna element; and
c. a bottom cover section enclosing the chip and joined to the top cover section,
whereby the package provides multiple input-multiple output support on the chip.

2. The package of claim 1, wherein the top cover section includes two antenna elements resonating at different polarizations.

3. The package of claim 2, wherein the different polarizations include orthogonal polarizations.

4. The package of claim 1, wherein the top cover section includes two, top and bottom plates.

5. The package of claim 4, wherein each plate includes a printed circuit board (PCB) layer.

6. The package of claim 4, wherein at least one plate includes a plurality of printed circuit board (PCB) layers.

7. The package of claim 1, wherein the top cover section includes more than two antenna elements formed on the external surface, the antenna elements having two different polarizations.

8. The package of claim 1, wherein the antenna element is formed by printing.

9. The package of claim 1, wherein the at least one antenna feed includes a via formed in the top cover section.

10. The package of claim 4, wherein the at least one antenna feed includes a radiating coupling slot formed in the top cover section.

11. An electronic package comprising:
a. a top cover section having an integrated antenna with at least two elements resonating at different polarizations formed on an external surface thereof;
b. a radio frequency (RF) chip mounted on an internal surface of the top cover section and functionally coupled to the antenna elements to provide the different polarizations; and
c. a bottom cover section shaped to accommodate the RF chip, the top and bottom sections joinable into a single package unit.

12. The package of claim 11, further comprising a plurality of leads used to connect the RF chip and package mechanically and electrically to a package carrier.

13. The package of claim 11, wherein the different polarizations are two orthogonal polarizations.

14. The package of claim 11, wherein the at least one antenna feed includes a via formed in the top cover section.

15. The package of claim 12, wherein the top cover section includes two, top and bottom plates.

16. The package of claim 15, wherein the antenna feed includes a radiating coupling slot formed in the top cover section.

17. A method for providing an electronic package for an RF chip, comprising the step of:
a providing a top cover section having an integrated antenna with a plurality of antenna elements resonating at different polarizations formed on an external surface thereof;
b. providing a bottom cover section shaped to accommodate a RF chip, the top and bottom sections joinable into a single package unit;
c. mounting the RF chip on an internal surface of the top cover; and
d. coupling the RF chip to the antenna elements to provide antenna resonances at different polarizations.

18. The method of claim 17, wherein the step of coupling the RF chip to the antenna elements to provide antenna resonances at different polarizations includes providing antenna feeds formed in the top cover surface, the antenna feeds connected respectively to RF circuitry on the RF chip and to the antenna element.

19. The method of claim 18, wherein the providing antenna feeds include providing respective radiating coupling slots formed in the top cover section.

20. The method of claim 18, wherein the providing antenna feeds include providing respective vias formed in the top cover section.
